(19) United States
(12) Patent Application Publication
(10) Pub. No.: US 2016/0129403 A1
(43) Pub. Date: May 12, 2016

(54) NOVEL NANOSTRUCTURED MEMBRANE SEPARATORS AND USES THEREOF

(71) Applicant: THE AMERICAN UNIVERSITY IN CAIRO, New York, NY (US)

(72) Inventors: Mohamed Serry, New Cairo (EG); Abdel Hameed Sharaf, New Cairo (EG); Mohamed Shaban, New Cairo (EG); Asmaa Gamal, New Cairo (EG)

(21) Appl. No.: 14/893,619

(22) PCT Filed: May 29, 2014
(86) PCT No.: PCT/US14/39953

§ 371 Date: Nov. 24, 2015

Related U.S. Application Data
(60) Provisional application No. 61/828,294, filed on May 29, 2013.

(51) Int. Cl. B01D 71/02; G01N 27/447; B01D 61/02

(52) U.S. Cl. CPC B01D 71/025; B01D 61/027; G01N 27/447

(57) ABSTRACT

Ultrahigh sensitive methods useful for separation, preconcentration, and detection of heavy metal ions in aqueous media are provided. Also provided are novel nanostructure separators useful for separation, preconcentration, and detection of heavy metal ions in aqueous media.

### FIELD

Provided herein are novel nanostructured separators useful for single stage separation, preconcentration, and detection of toxic heavy metals. Also provided are methods useful for separation, preconcentration, and detection of toxic heavy metal ions in aqueous media using the nanostructure separators.

### BACKGROUND

Environmental contamination of Hg(II) and Pb(II) can result in poisoning and death [(a) Sherif A. El-Salty, M. A. Shenashen Trends in Analytical Chemistry, Vol. 38, 2012 98. (b) Z. Cheng, K. A. Foland, Appl. Geochem, 2005, 20, 353] or severe damage to the brain [R. P. Mason, J. R. Reinfelder, F. M. M. Morel, Water Air Soil Pollut., 1995, 80, 915], kidneys, nervous system, and red blood cells [S. Toplan, D. Ozcelik, T. Gulyasar, M. C. Akyocu, J. Trace Elements Med. Biol., 2004, 18, 179]. Governments throughout the world are continuing to tighten contaminant concentration limits and guidelines pertaining to heavy metals ((HMs) in industrial and environmental waters. Additionally, the World Health Organization recommends the standard allowance for water quality to be less than 10 ppb for Pb, Cd, Hg, and other toxic metal ions. Despite the increasing demands for simple and rapid monitoring of HMs in water, the sensitivities of commercial methods are insufficient to meet the recommended concentration guidelines[Nora Savage et al. Mamadou Diallo, Jeremiah Duncan, Anita Street, Richard Sustich (eds.), Nanotechnology Applications for Clean Water, 417-425, 2009 William Andrew Inc.]. Additionally, the methods are also incapable of online (instant) monitoring and require several preprocessing stages.

Accordingly, there is an urgent need for simple, inexpensive, sensitive and selective detection of metal ions for a wide range of applications including industrial process management, chemical threat detection, medical diagnostics, food quality control and environmental monitoring.

The rapid online detection of heavy metals has, moreover, emerged as a pressing issue for developed and underdeveloped communities for various applications ranging from environmental control and water quality to monitoring of fish and plant borne poisoning. Conventional methods to detect heavy metal concentrations usually require sampling and transportation to central labs. Such methods are time consuming, typically requiring more than 24 hours. In addition, the lack of selectivity of sensors in the presence of other types of contaminants in complex solutions is a common problem that directly affects conventional sensor's sensitivity and functionality [S. R. J.-Philippe, N. Labbé, J. A. Franklin, A. Johnson, “Detection of mercury and other metals in mercury contaminated soils using mid-infrared spectroscopy”, Proceedings of the International Academy of Ecology and Environmental Sciences, vol. 2, pp. 139-149, 2012].

The function of a heavy metal sensor is to transduce the concentration of heavy metal ions in a solution (e.g., Hg²⁺, Cd²⁺, Pb²⁺, Cu²⁺, Co²⁺and Ni²⁺) into a detectable signal. Recent advances in MEMS and Nano technologies have provided unique advantages for developing rapid, portable and sensitive bio-chemical sensors [I. Voiculescu, M. Zaghloul, N. Nachchinarkkinian, “Microfabricated Chemical Preconcentrators for Gas-Phase Microanalytical Detection Systems”, Trends in Analytical Chemistry, vol. 27, pp. 327-343, 2008].

Impedance based sensors offer the advantages of rapid response, ease of fabrication, and high sensitivity [P. Silley, S. Forsythe, “Impedance microbiology-a rapid change for microbiologists,” J. Appl. Bacteriol., vol. 80, pp. 233-243, 1996]. As reported in the literature, impedance-based sensors have been used to detect various bio-chemical ions/molecules with high sensitivity [A. M. Johnson, D. R. Sadoway, Michael J. Cima, and R. Langer, “Design and Testing of an Impedance-Based Sensor for Monitoring Drug Delivery,” J. Electrochem. Soc., vol 152, pp. 6-11, 2005].

Given the aforementioned challenges, the determination of HMs in the aquatic environment is of tremendous interest due to their hazardous effects on the ecosystem and ultimately human health. Methods useful for detection and separation of HMs still remain highly challenging.

The citation of references herein shall not be construed as an admission that such is prior art to the present invention.

### SUMMARY OF THE INVENTION

There remains a need for new devices capable of detecting and separating HMs and for novel methods to detect and separate HMs. The compositions and methods described herein are directed toward these ends.

In one aspect, the present invention discloses the use of nanostructures or nanostructured membranes useful for separation, preconcentration, or detection of trace levels of toxic and/or non-toxic analytes. In one embodiment, the analytes are non-toxic analytes. In another embodiment, the analytes are toxic analytes. In one embodiment, the toxic analytes are heavy metal ions.

In another aspect, the present invention discloses the use of nanostructures or nanostructured membranes useful for separation, preconcentration, or detection of heavy metal ions in aqueous media.

In certain aspects, provided herein are compositions of nanostructures or nanostructured membranes useful for separation, preconcentration, or detection of heavy metal ions in aqueous media.

In a particular aspect, the present invention provides nanostructures or nanostructured membrane separators comprising porous anodic alumina (PAA) membrane functionalized with porous metal nanoparticles and porous metal nanoshells useful for separation, preconcentration, or detection of heavy metal ions in aqueous media.

In another particular aspect, the present invention provides nanostructures or nanostructured membrane separators comprising a nanoporous anodic alumina membrane functionalized with a) highly ordered hexagonal arrays of metal nanoparticles with sub-gaps on the top surface and b) ultrathin porous metal nanoshells on the interior walls of the pores with sub-gaps; and the nanostructured membrane is useful for separation, preconcentration, or detection of heavy metal ions in aqueous media.

In yet another particular aspect, the present invention provides processes for separation, preconcentration, or detection of heavy metal ions in aqueous media using the nanostructure or the nanostructured membrane separator as described herein.

Other objects and advantages will become apparent to those skilled in the art from a consideration of the ensuing detailed description.

### BRIEF DESCRIPTION OF THE DRAWINGS

FIG. 1: (a) Schematic of the microfluidic platform integrated with nanoporous alumina membrane functionalized with hexagonal arrays of metal nanoparticles uniformly attached on the surface and porous nanoshell layer on the interior pore walls, (b) SEM of membrane integration on the bottom of microfluidic channels.

FIG. 2: Schematic showing the separation/detection mechanism and the flow behaviors of heavy metalelectrolyte droplets driven by contact angle mismatch capillary action. Step 1—Flow behaviors of heavy metal contaminated water on hydrophobic surface and hydrophilic pores; Step 2—Entrapment/Adsorption of heavy metal ions on the hydrophilic metal surface; and Step 3—Evaporation of contaminated water and impedance change measurement (AZ).

FIG. 3: Cross-section schematic of water droplet on PAA holes in transition between Cassie-Baxter and Wenzel's behaviors.

FIG. 4: Schematic showing the Impedance Signal (R) vs. Time (t) which can be divided into three distinguished regions, Region 1—before adding deionized (DI) water with heavy ions; Region 2—Diffusion region in which the positive ions in DI water diffuse into the electrons inside the film (this results in an increase in the resistance of both the DI water and the film; and Region 3—Saturation region, all positive ions are approximately diffused into the metal film and the film resistance has a new value.

FIG. 5: (a) Top view AFM image showing highly packed hexagonally ordered Au nanoparticles, and (b) cross-sectional view SEM of nanoporous membrane, the enlarged part shows the porous nanoshell hydrophilic layer on the wall interior with sub-gaps <15 nm.

FIG. 6: (a) Top view AFM image showing highly packed hexagonally ordered Pt nanoparticles, and (b) cross-sectional view SEM of nanoporous membrane decorated with Pt nanoparticles deposited by using Atomic Layer Deposition (ALD) techniques.

FIG. 7: Different impedance behaviors of membrane coated with 220° A Pt subject to different heavy metal types (Pb²⁺, Hg²⁺, or Cu²⁺) and concentrations.

FIG. 8: Impedance change vs. concentration for different membrane structures subject to different heavy metal concentrations.

### DEFINITIONS

“Aqueous media” refers to any aquatic or test sample, such as, for example, a water sample isolated from a water supply, a solution of electrolytes in water, or a solution of heavy metal ions in water.

“Sub-gap” refers to the gap between two adjacent nanoparticles or two adjacent nanoshells. Subgaps are different in different places on the nanostructure. Those located on the top surface have wider gaps, for example, ˜45 nm; and those inside the pores have narrower gaps, for example, around 1 nm.

“Ultrathin” refers to a very thin film or a thin film which measures less than 10 nm in thickness.

“Contact angle” refers to the surface angles at the liquid/solid/air or liquid/solid interfaces.

### DETAILED DESCRIPTION OF THE PREFERRED EMBODIMENTS

Microfluidic chip devices require minuscule amounts of samples and reagents and offer high surface to volume ratio, which renders them useful for localizing target heavy metal ions in test solutions. In addition, fast mass transport in the microchannel reduces analysis time. Integration of impedance-based sensors with microfluidic fluid manipulation platforms provides additional unprecedented detection advantages.

Thus, in one aspect, the present invention provides a novel microfluidic separation/preconcentration and detection method based on nanostructured membranes functionalized with metal nanoparticles. In one embodiment, the separation, preconcentration and detection of target heavy metal ions are all performed by the same nanostructure membrane without the need for time-consuming and complex sample preparation steps. In another embodiment, the membrane is suitable for integration with lap-on-chip devices.

In another aspect, the present invention discloses the use of nanostructures or nanostructured membranes useful for separation, preconcentration, or detection of trace levels of toxic analytes. In one embodiment, the toxic analytes are heavy metal ions.

In yet another aspect, the present invention discloses the use of nanostructures or nanostructured membranes useful for separation, preconcentration, or detection of heavy metal ions in aqueous media.

In certain aspects, provided herein are compositions of nanostructures or nanostructured membranes useful for separation, preconcentration, or detection of heavy metal ions in aqueous media.

In a particular aspect, the present invention provides nanostructures comprising a porous anodic alumina membrane functionalized with porous metal nanoparticles and porous metal nanoshells useful for separation, preconcentration, or detection of heavy metal ions in aqueous media.

In one embodiment, with respect to the nanostructure, the anodic alumina membrane is a nanoporous anodic alumina membrane.

In one embodiment, with respect to the nanostructure, the anodic alumina membrane is functionalized with highly ordered hexagonal arrays of metal nanoparticles on the top surface.

In one embodiment, with respect to the nanostructure, the metal of the metal nanoparticles is gold. In another embodiment, the metal of the metal nanoparticles is platinum. In another embodiment, the metal of the metal nanoparticles is highly doped silicon germanium (SiGe), or Ge.

In one embodiment, with respect to the nanostructure, the anodic alumina membrane is functionalized with highly ordered hexagonal arrays of metal nanoparticles with sub-gaps on the top surface.

In one embodiment, with respect to the nanostructure, the anodic alumina membrane is functionalized with highly ordered hexagonal arrays of metal nanoparticles with sub-gaps on the top surface; and the sub-gaps are 10-50 nm wide. In one embodiment, the sub-gaps are 10-40 nm wide. In another embodiment, the sub-gaps are 15-35 nm wide. In yet another embodiment, the sub-gaps are 20-30 nm wide. In yet another embodiment, the sub-gaps are around 25 nm wide. In yet another embodiment, the sub-gaps are about 25 nm wide. In a particular embodiment, the sub-gaps are about 45 nm wide.

In one embodiment, with respect to the nanostructure, the anodic alumina membrane is functionalized with porous metal nanoshells on the interior walls of the pores.

In one embodiment, with respect to the nanostructure, the metal of the metal nanoshells is gold. In another embodiment, the metal of the metal nanoshells is platinum. In another embodiment, the metal of the metal nanoshells is highly doped silicon germanium (SiGe), or Ge.

In one embodiment, with respect to the nanostructure, the anodic alumina membrane is functionalized with porous metal nanoshells on the interior walls of the pores with sub-gaps. In one embodiment, the interior sub-gaps measure around 1-20 nm. In another embodiment, the sub-gaps measure around 1-15 nm. In yet another embodiment, the sub-gaps measure less than 15 nm. In a particular embodiment, the sub-gaps measure around 1-5 nm. In another particular embodiment, the sub-gaps measure around 1-3 nm. In a more particular embodiment, the sub-gaps measure around 1 nm.

In one embodiment, with respect to the nanostructure, the metal nanoshells are ultrathin porous metal nanoshells.

In one embodiment, with respect to the nanostructure, the heavy metal ion is Hg(II), Cd(II), Pb(II), Cu(II), Co(II), or Ni(II) (or Hg²⁺, Cd²⁺, Pb²⁺, Cu²⁺, Co²⁺ and Ni²⁺), or combinations thereof.

In one embodiment, with respect to the nanostructure, the aqueous media is an electrolyte solution.

In another embodiment, with respect to the nanostructure, the aqueous media is a test solution.

In another embodiment, with respect to the nanostructure, the aqueous media is a solution containing heavy metal ions. In yet another embodiment, the aqueous media is an aquatic sample.

In one embodiment, with respect to the nanostructure, the aqueous media is a solution containing heavy metal ions; and the heavy metal ion is Hg(II), Cd(II), Pb(II), Cu(II), Co(II), or Ni(II) (or Hg²⁺, Cd²⁺, Pb²⁺, Cu²⁺, Co²⁺ and Ni²⁺) or combinations thereof.

In another particular aspect, the present invention provides nanostructured membrane separators comprising a nanoporous anodic alumina membrane functionalized with a) highly ordered hexagonal arrays of metal nanoparticles with sub-gaps on the top surface and b) ultrathin porous metal nanoshells on the interior walls of the pores with sub-gaps; and the nanostructured membrane is useful for separation, preconcentration, or detection of heavy metal ions in aqueous media.

In one embodiment, with respect to the nanostructured membrane separator, the metal in the metal nanoparticles is gold. In another embodiment, the metal is platinum. In another embodiment, the metal in metal nanoshells is highly doped silicon germanium (SiGe), or Ge.

In one embodiment, with respect to the nanostructured membrane separator, the sub-gaps on the top measure around 10-50 nm, or around 10-40 nm. In another embodiment, the sub-gaps on the top measure around 15-35 nm. In yet another embodiment, the sub-gaps on the top measure around 20-30 nm. In yet another embodiment, the sub-gaps on the top measure around 25 nm. In yet another embodiment, the sub-gaps on the top measure about 25 nm. In yet another embodiment, the sub-gaps on the top measure about 45 nm.

In one embodiment, with respect to the nanostructured membrane separator, the interior sub-gaps of the nanoshells measure around 1-20 nm. In another embodiment, the sub-gaps of the nanoshells measure around 1-15 nm. In yet another embodiment, the sub-gaps of the nanoshells measure less than 15 nm, less than 10 nm, less than 5 nm, or less than 2 nm.

In one embodiment, with respect to the nanostructured membrane separator, the heavy metal ion is Hg(II), Cd(II), Pb(II), Cu(II), Co(II), or Ni(II), (or Hg²⁺, Cd²⁺, Pb²⁺, Cu²⁺, Co²⁺ and Ni²⁺) or combinations thereof. In another embodiment, the heavy metal ion is Hg(II), Cd(II), Pb(II), or Cu(II), (or Hg²⁺, Cd²⁺, Pb²⁺, or Cu²⁺) or combinations thereof.

In one embodiment, with respect to the nanostructured membrane separator, the aqueous media is an electrolyte solution. In another embodiment, the aqueous media is a test solution. In another embodiment, the aqueous media is a water sample of water supply. In yet another embodiment, the aqueous media is a solution containing heavy metal ions. In yet another embodiment, the aqueous media is an aquatic sample.

In one embodiment, with respect to the nanostructured membrane separator, the aqueous media is a solution containing heavy metal ions; and the heavy metal ion is Hg(II), Cd(II), Pb(II), Cu(II), Co(II), or Ni(II) or combinations thereof

In one embodiment, with respect to the nanostructure, the ion separation or preconcentration is achieved by inducing high contact angle mismatch between aqueous media relative to the top surface and the porous nanoshells inside the pores.

In one embodiment, with respect to the nanostructured membrane separator the ion separation or preconcentration is achieved by inducing high contact angle mismatch between aqueous media relative to the top surface and the porous nanoshells inside the pores; and wherein the contact angle at the top surface is between 100° and 160°, between 110° and 150°, between 120° and 140°, or between 130° and 140°. In a particular embodiment, the angle is around 135°.

In one embodiment, with respect to the nanostructure or the nanostructured membrane separator, the ion separation or preconcentration is achieved by inducing high contact angle mismatch between aqueous media relative to the top surface and the porous nanoshells inside the pores; and wherein the contact angle at the top surface is more than or equal to 135°

In one embodiment, with respect to the nanostructure or the nanostructured membrane separator, the ion separation or preconcentration is achieved by inducing high contact angle mismatch between aqueous media relative to the top surface and the porous nanoshells inside the pores; and wherein the contact angle inside the pores is between 20-80 ° or 22.5-79°.

In one embodiment, with respect to the nanostructure or the nanostructured membrane separator, the ion separation or preconcentration is achieved by inducing high contact angle mismatch between aqueous media relative to the top surface and the porous nanoshells inside the pores; and wherein the contact angle inside the pores is between 22.5-79°.

In one embodiment, with respect to the nanostructure or the nanostructured membrane separator, the ion separation or preconcentration occurs inside the pores of the metal nanoshells.

In one embodiment, with respect to the nanostructure or the nanostructured membrane separator, the nanostructure is prepared by growing hexagonally ordered metal nanoparticles and simultaneously forming porous film of metal nanoshell on the surface of the nanoporous anodic alumina membrane.

In one embodiment, with respect to the nanostructure or the nanostructured membrane separator, the hexagonally ordered metal nanoparticles are grown on top and the porous film of metal nanoshell is formed on the interior wall of the pores.

In one embodiment, with respect to the nanostructure or the nanostructured membrane separator, the hexagonally ordered metal nanoparticles are of about 40 nm in diameter and about 50 nm in height.

In one embodiment, with respect to the nanostructure or the nanostructured membrane separator, the metal is Au or Pt.

In one embodiment, with respect to the nanostructure or the nanostructured membrane separator, the metal is a highly doped semiconductor such as SiGe or Ge.

In yet another particular aspect, the present invention provides processes for separation, preconcentration, or detection of heavy metal ions in aqueous media using the nanostructure or the nanostructured membrane separator as described herein.

In one embodiment, with respect to the nanostructure, the nanostructured membrane separator, or the process, the detection of heavy metal ions is electrochemical detection.

In another embodiment, the composition of the present invention can be used for separation, preconcentration, or detection of extremely toxic heavy metal ions in aquatic samples.

Additional embodiments within the scope provided herein are set forth in non-limiting fashion elsewhere herein and in the examples. It should be understood that these examples are for illustrative purposes only and are not to be construed as limiting in any manner.

### Nanostructured Membrane Separators

Porous anodic alumina (PAA) membranes are usually functionalized with metal particles, so that their electronic, mechanical, and optical properties are significantly improved, which makes them more suitable for sensing applications [M. Shaban, M. Serry, “A New Sensor for Heavy Metals Detection in Aqueous Media,” Proc. of IEEE Sensors 2012, Taipei, Taiwan, 28-31 Oct. 2012].

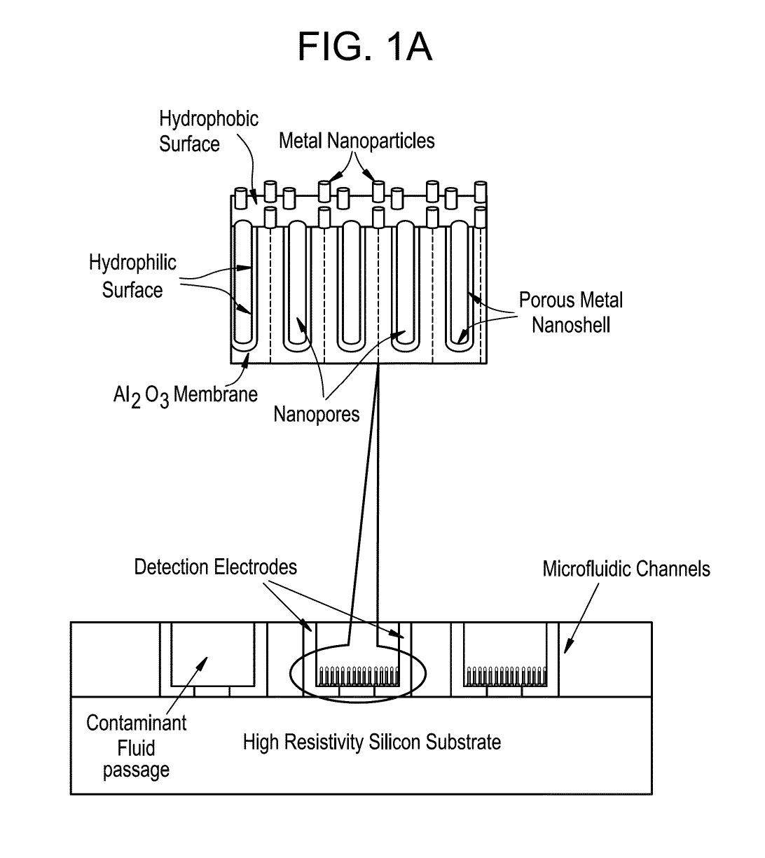

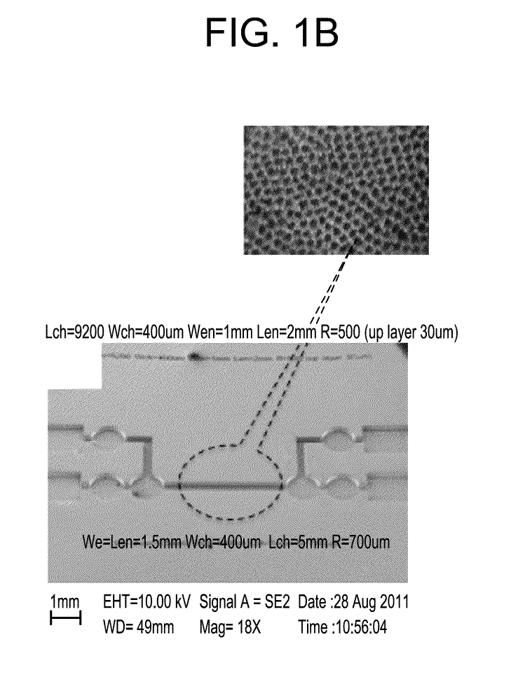

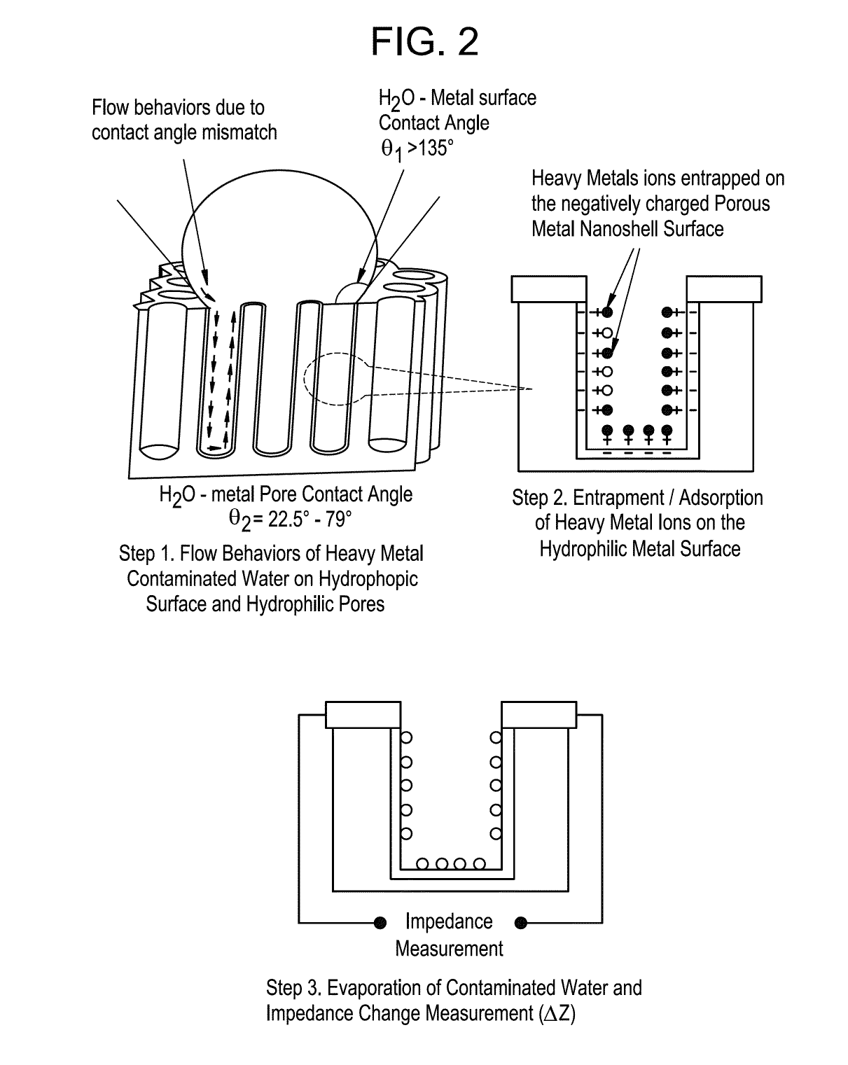

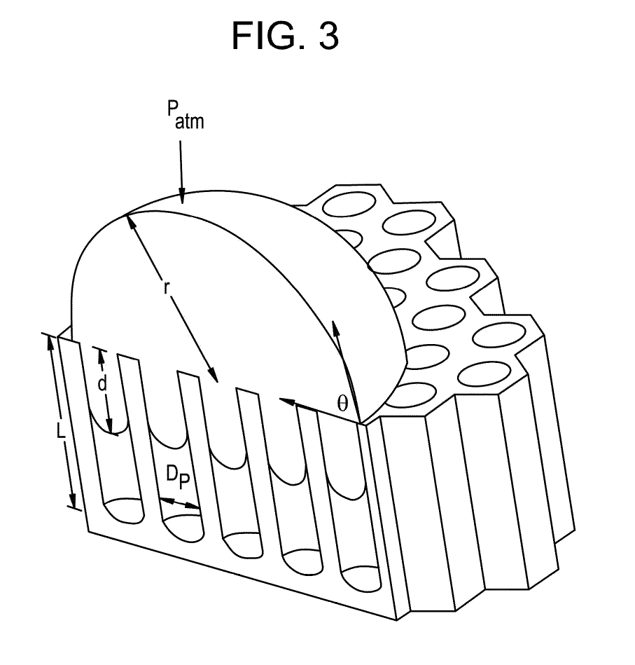

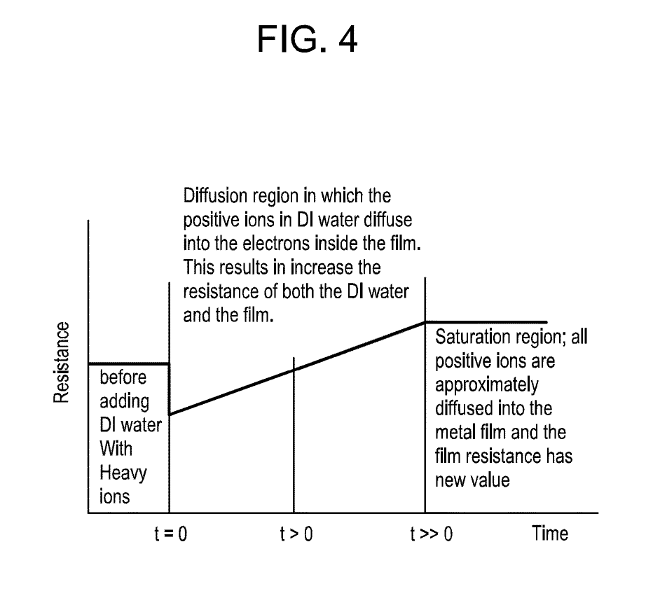

The nanostructure or nanostructured membrane separator of the present invention is based on a unique nanostructure consisting of nanoporous anodic alumina membrane functionalized with highly ordered hexagonal arrays of metal nanoparticles (for example, Au or Pt) with 25 nm sub-gaps on the top surface and ultrathin porous metal nanoshells on the interior walls of the pores with <15 nm sub-gaps (FIG. 1(a)). The nanoscale separation and preconcentration schemes are based on inducing high contact angle mismatch between the liquid electrolyte relative to the top surface and the porous nanoshells inside the pores which drives the flow inside the pores by capillary action and accelerates the migration of heavy metal ions into the nanopores to attach onto the negatively charged metal surface and preconcentrate at the porous metal nanoshells, thereby changing the impedance of the nanostructure. Contact angle mismatch and capillary driven flow have been achieved by controlling the surface tension behavior of the droplets of heavy metal electrolyte solution on the surface of the structure relative to the pores (FIG. 2). At the surface, hydrophobic behavior is induced due to the highly packed hexagonal arrays of metal nanoparticles (FIGS. 3(a) and 4(a)) with contact angles ≧135°, whereas, inside the pores, the electrolyte solution to metal nanoshell interaction exhibits a hydrophilic behavior with contact angles ranging between 22.5° to 79° depending on the porosity and type of metal. This leads to separation and preconcentration of the heavy metal ions (e.g., Hg²⁺, Cu²⁺, Pb²⁺, and Cd²⁺) inside the 15 nm sub-gap pores of the metal nanoshells.

This technique has several advantages as compared to conventional bulk or micro-separators which can be summarized as follows: 1) very limited pressure drop due to the integration at the bottom of the microchannels (FIG. 1(b)), which makes this technique suitable for aqueous and not limited to gaseous media, 2) virtually unlimited number of sorption sites are available on the porous nanoshells which increases the detection efficiency/accuracy, 3) high sensitivity due to the high surface area of the nanopores, 4) very fast and simultaneous separation, preconcentration, and detection without the need for a multi-stage platform, and 5) gravitationally-insensitive as compared to bulk systems.

### Wetablility

The wetability of the metal nanoparticle functionalized porous membrane is modeled on the Cassie-Baxter and Wenzel equations [M. E. Schrader, G. I. Loeb, Modern Approaches to Wettability, Plenum Press, 1992]. In the case of the Cassie-Baxter model, the liquid droplet sits above the solid surface and air pockets underneath it. However, in the present case, because of the contact angle mismatch between the surface and the pores of the membrane, there is a transitional state between Cassie-Baxter and Wenzel models used to explain the wetting behavior with the pores walls partially wetted by the liquid with air trapped within the pores. To explain what happens, assume that the air inside the pore behaves like an ideal gas and there is no escaped air from the pores after adding the liquid which can be attributed to the small size of the pore diameter (cf. FIG. 3).

Before adding the droplet, the pressure P₁ which effect on the air inside the pore with volume,

$${V}_{1} = \frac{π {D}_{p}^{2} L}{4} \qquad ( 1 )$$

is equal to Pₐₜₘ. After adding the droplet, some penetration of liquid inside the pore has to occur, the extent of the penetration is due to the balance of Laplace pressure of the droplet on the PAA surface which equal to:

2γₗᵣ/r (2)

so the pressure which affects the trapped air now becomes,

$${P}_{atm} + \frac{2 {γ}_{iv} cos θ}{r} \qquad ( 3 )$$

and the volume of air pocket,

$${V}_{2} = \frac{π {D}_{p}^{2} ( L - d )}{4} \qquad ( 4 )$$

substituting in Boyle's law of gases,

$$d = \frac{2 L {γ}_{iv} cos θ}{{rP}_{atm} + 2 {γ}_{iv} cos θ} \qquad ( 5 )$$

so we can say that the average height of the liquid column inside each of the pores d depends on the contact angle θ, the droplet volume r and the depth of the pore.

### Microfluidic Flow Behavior

Microfluidic flow is induced by capillary action through the contact angle mismatch between the liquid relative to the top surface, θ_{CB} and that relative to the porous nanoshells inside the pores, θ₆₅ , which can be approximated by the Cassie-Baxter model as,

cos θ_{CB}=(cos θ_{γ}+1)−1 (6)

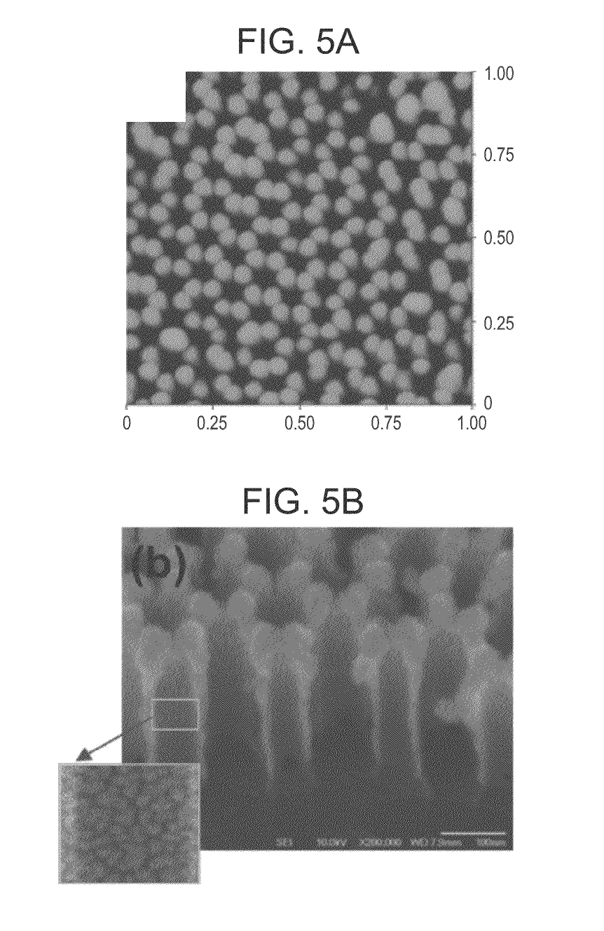

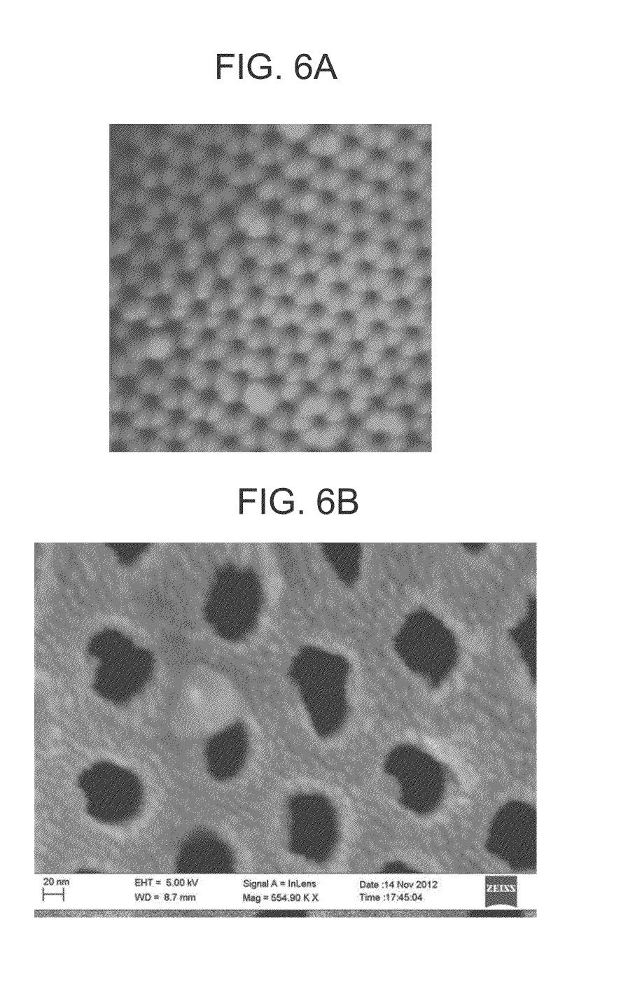

Contact angle mismatch has been achieved by controlling the surface tension behavior of the droplet of heavy metal electrolyte solution on the surface of the structure relative to the pores (FIGS. 5(a) and 6(a)). At the surface, hydrophobic behavior is induced due to the highly packed hexagonal arrays of metal nanoparticles with contact angles ≧135°, whereas, inside the pores, the electrolyte solution to metal nanoshell interaction exhibits a hydrophilic behavior with contact angles ranging between 22.5° to 79° depending on the porosity and type of metal.

### Impedance Model

The membrane can be modeled as resistor, R_{f}, this resistor is a function of the resistivity of the material, ρ, as well as the characteristic measurement length, L, of the film and its cross section area, A,

$${R}_{f} = \frac{ρ L}{A} \qquad ( 7 )$$

Consider the value of the film resistance is Rₒ, and the heavy metal ions electrolyte solution has a resistance of R_{DI}. Adding a heavy metal electrolyte solution changes the resistance of the film. These changes can be divided into three distinguished stages as follows, 1) Stage 1, at time t=0 sec, the system can be modeled as two parallel resistors. The equivalent resistance is smaller than Rₒ,

$${R}_{t , 1} = \frac{{R}_{o} {R}_{DI}}{{R}_{o} + {R}_{DI}} < {R}_{o} \qquad ( 8 )$$

2) Stage 2, at t >0, the positive ions in the solution will defuse in the film and make chemical bonds with the negative charges of the metal film. This process results in increasing the system resistance. The process will continue until reaching the saturation region, which is explained in the next stage,

$${R}_{t , 2} = \frac{{R}_{o} {R}_{DI}}{{R}_{o} + {R}_{DI}} < {R}_{t , 1} \qquad ( 9 )$$

3) Stage 3, at t >>0, the diffusion process will continue until all positive ions diffuse with the negative charges. At this point the system is saturated and the resistance will not change.

$${R}_{t , 3} = \frac{{R}_{o} {R}_{DI}}{{R}_{o} + {R}_{DI}} ≅ {R}_{fn} > {R}_{t , 2} \qquad ( 10 )$$

where R_{fn} is the new resistance of the film due to the chemical bonds, which changes the film resistivity. The three stages that distinguish the impedance behavior during detection can be demonstrated using the schematic in FIG. 4.

### EXAMPLE 1

### Metal Nanoparticle Functionalized Membranes

An efficient method to decorate the surface of the nanoporous anodic alumina membrane with highly ordered metal nanoparticles (in order to induce hydrophobic effect) by growing highly-packed hexagonally ordered Au or Pt nanoparticle of diameters ˜40 nm and height ˜52 nm on top, simultaneously with the formation of an ultrathin porous film of metal nanoshell on the interior wall of the pores is demonstrated (FIGS. 5 and 6). FIG. 5(b) shows a cross-sectional SEM image of the porous Au nanoshell on the pore walls where ion entrapment takes place. The figure also shows very narrow sub-gaps (<15 nm) between the neighboring pores on the interior nanoshells as seen in the cross-sectional SEM image. Furthermore, it could be seen from the enlarged part of FIG. 5(b) that Au porous nanoshells were also the bottom of the pores forming a continuous conductive film.

### EXAMPLE 2

### Impedance Measurement Procedure

Different membrane separators were loaded with heavy metal electrolyte solutions. The aqueous media is simultaneously evaporated; the change of impedance could be detected online using Agilent 4395A network analyzer with impedance option 4395A-010, which adds the impedance measurement function.

Impedance Profile vs. Time

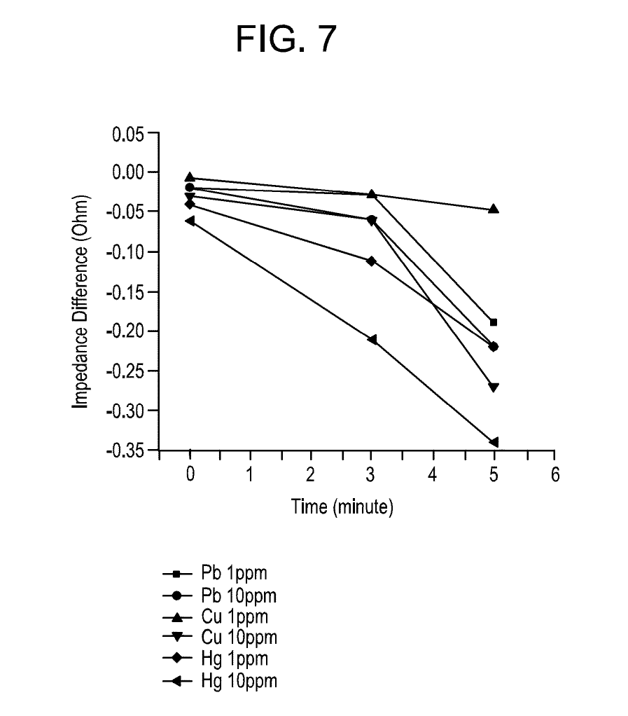

Upon the addition of electrolytes, impedance profiles were detected for different membrane structures with different types and concentrations of heavy metals ions (Pb²⁺, Hg²⁺, Cu²⁺) over a range of 5 minutes. Different impedance behaviors of a membrane coated with 220° A Pt are shown in FIG. 7. The behavior is consistent with the first stage of the impedance model discussed herein.

Sensing Sensitivity and Selectivity

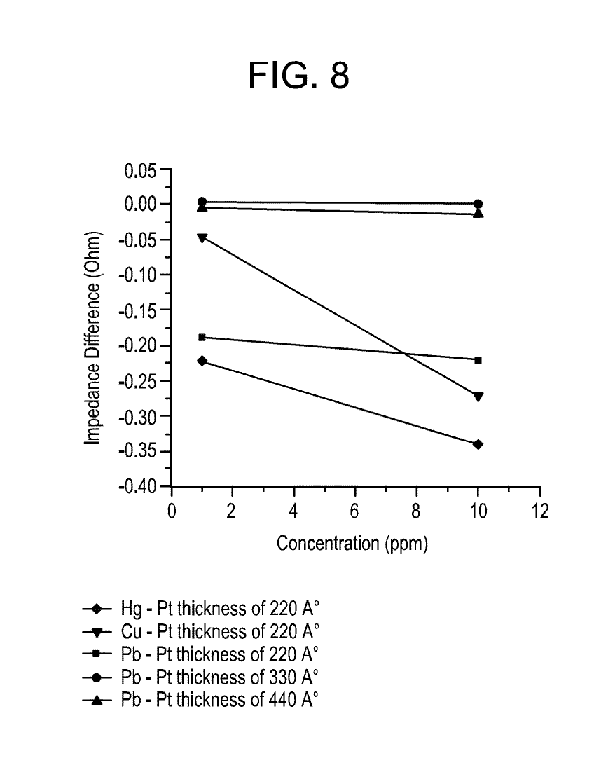

An efficient and fast response with sensitivities ranging from 5 to 30 mΩ/ppm has been observed as shown in FIG. 8. It was also observed that membranes coated with Au have significantly higher sensitivities as compared to those coated with Pt for the same concentrations.

A new microfluidic separation/preconcentration technique based on nanostructured membranes functionalized with metal nanoparticles has therefore been developed.

The ingenuity of this technique relies in part on the fact that separation; preconcentration; and detection of targeted ions are all performed by the same structure without the need for time-consuming sample preparation steps. The device is based on a unique nanostructure consisting of nanoporous anodic alumina membrane functionalized with highly ordered hexagonal arrays of metal nanoparticles (i.e., Au or Pt) with 25 nm sub-gaps on the top surface and ultrathin porous metal nanoshells on the interior walls of the pores with <15 nm sub-gaps. Modeling of the flow, separation and impedance behaviors have been performed and verified experimentally.

From the foregoing description, various modifications and changes in the compositions and methods provided herein will occur to those skilled in the art. All such modifications coming within the scope of the appended claims are intended to be included therein.

All publications, including but not limited to patents and patent applications, cited in this specification are herein incorporated by reference as if each individual publication were specifically and individually indicated to be incorporated by reference herein as though fully set forth.

What is claimed is:

1. A nanostructure comprising porous anodic alumina membrane functionalized with porous metal nanoparticles and porous metal nanoshells useful for separation, preconcentration, or detection of heavy metal ions in aqueous media.

2. The nanostructure according to claim 1, wherein the anodic alumina membrane is a nanoporous anodic alumina membrane.

3. The nanostructure according to either of claim 1 or 2, wherein the anodic alumina membrane is functionalized with highly ordered hexagonal arrays of metal nanoparticles on the top surface.

4. The nanostructure according to any one of claims 1-3, wherein the metal in metal nanoparticles is gold, platinum, highly doped silicon germanium (SiGe), or Ge.

5. The nanostructure according to any one of claims 1-3, wherein the anodic alumina membrane is functionalized with highly ordered hexagonal arrays of metal nanoparticles with sub-gaps on the top surface.

6. The nanostructure according to claim 5, wherein the sub-gaps are 10-50, or 10-40 nm wide.

7. The nanostructure according to claim 5, wherein the sub-gaps are 15-35 nm wide.

8. The nanostructure according to claim 5, wherein the sub-gaps are 20-30 nm wide.

9. The nanostructure according to claim 5, wherein the sub-gaps are around 25 nm wide.

10. The nanostructure according to claim 5, wherein the sub-gaps are about 25 nm wide.

11. The nanostructure according to any one of claims 1-10, wherein the anodic alumina membrane is functionalized with porous metal nanoshells on the interior walls of the pores.

12. The nanostructure according to any one of claims 1-11, wherein the metal in metal nanoshells is gold or platinum.

13. The nanostructure according to any one of claims 1-12, wherein the anodic alumina membrane is functionalized with porous metal nanoshells on the interior walls of the pores with sub-gaps.

14. The nanostructure according to claim 13, wherein the metal nanoshells are ultrathin porous metal nanoshells.

15. The nanostructure according to claim 13, wherein the sub-gaps are 1-20 nm.

16. The nanostructure according to claim 13, wherein the sub-gaps are 1-15 nm.

17. The nanostructure according to claim 13, wherein the sub-gaps are less than 15 nm, less than 10 nm, less than 5 nm, or less than 2 nm.

18. The nanostructure according to any one of claims 1-17, wherein the heavy metal ion is Hg(II), Cd(II), Pb(II), Cu(II), Co(II), or Ni(II), (or Hg²⁺, Cd²⁺, Pb²⁺, Cu²⁺, Co²⁺ and Ni²⁺) or combinations thereof.

19. The nanostructure according to any one of claims 1-18, wherein the aqueous media is an electrolyte solution.

20. The nanostructure according to any one of claims 1-18, wherein the aqueous media is a test solution.

21. The nanostructure according to any one of claims 1-18, wherein the aqueous media is a solution containing heavy metal ions.

22. The nanostructure according to any one of claims 1-18, wherein the aqueous media is a solution containing heavy metal ions; and the heavy metal ion is Hg(II), Cd(II), Pb(II), Cu(II), CO(II), or Ni(II) (or HG²⁺, Cd²⁺, Pb²⁺, Cu²⁺, Co²⁺ and Ni₂₊) or combinations thereof.

23. The nanostructure according to any one of claims 1-18, wherein the aqueous media is a solution containing heavy metal ions; and the heavy metal ion is Hg(II), Cd(II), Pb(II), or Cu(II), or combinations thereof.

24. A nanostructured membrane separator comprising a nanoporous anodic alumina membrane functionalized with a) highly ordered hexagonal arrays of metal nanoparticles with sub-gaps on the top surface and b) ultrathin porous metal nanoshells on the interior walls of the pores with sub-gaps; wherein the nanostructured membrane is useful for separation, preconcentration, or detection of heavy metal ions in aqueous media.

25. The nanostructured membrane separator according to claim 24, wherein the metal in metal nanoparticles is gold, platinum, highly doped silicon germanium (SiGe), or Ge.

26. The nanostructured membrane separator according to claim 24, wherein the metal in metal nanoshells is gold or platinum.

27. The nanostructured membrane separator according to any one of claims 24-26, wherein the sub-gaps on the top measure around 10-50 or 10-40 nm.

28. The nanostructured membrane separator according to any one of claims 24-26, wherein the sub-gaps on the top measure around 15-35 nm.

29. The nanostructured membrane separator according to any one of claims 24-26, wherein the sub-gaps on the top measure around 20-30 nm.

30. The nanostructured membrane separator according to any one of claims 24-26, wherein the sub-gaps on the top measure around 25 nm.

31. The nanostructured membrane separator according to any one of claims 24-26, wherein the sub-gaps on the top measure about 25 nm.

32. The nanostructured membrane separator according to any one of claims 24-31, wherein the sub-gaps of the nanoshells measure around 1-20 nm.

33. The nanostructured membrane separator according to any one of claims 24-31, wherein the sub-gaps of the nanoshells measure around 1-15 nm.

34. The nanostructured membrane separator according to any one of claims 24-31, wherein the sub-gaps of the nanoshells measure less than 15 nm, less than 10 nm, less than 5 nm, or less than 2 nm.

35. The nanostructured membrane separator according to any one of claims 24-34, wherein the heavy metal ion is Hg(II), Cd(II), Pb(II), Cu(II), Co(II), or Ni(II), (or Hg²⁺, Cd²⁺, Pb²⁺, Cu²⁺, Co²⁺ and Ni²⁺) or combinations thereof.

36. The nanostructured membrane separator according to any one of claims 24-35, wherein the aqueous media is an electrolyte solution.

37. The nanostructured membrane separator according to any one of claims 24-35, wherein the aqueous media is a test solution.

38. The nanostructured membrane separator according to any one of claims 24-35, wherein the aqueous media is a solution containing heavy metal ions.

39. The nanostructured membrane separator according to any one of claims 24-38, wherein the aqueous media is a solution containing heavy metal ions; and the heavy metal ion is Hg(II), Cd(II), Pb(II), Cu(II), Co(II), or Ni(II) (or Hg²⁺, Cd²⁺, Pb²⁺, Cu²⁺, Co²⁺ and Ni²⁺) or combinations thereof.

40. The nanostructure or the nanostructured membrane separator according to any one of claims 1-39, wherein the ion separation or preconcentration is achieved by inducing high contact angle mismatch between aqueous media relative to the top surface and the porous nanoshells inside the pores.

41. The nanostructure or the nanostructured membrane separator according to any one of claims 1-39, wherein the ion separation or preconcentration is achieved by inducing high contact angle mismatch between aqueous media relative to the top surface and the porous nanoshells inside the pores; and wherein the contact angle at the surface is between 100° and 160°, between 110° and 150°, between 120° and 140°, or between 130° and 140°.

42. The nanostructure or the nanostructured membrane separator according to any one of claims 1-39, wherein the ion separation or preconcentration is achieved by inducing high contact angle mismatch between aqueous media relative to the top surface and the porous nanoshells inside the pores; and wherein the contact angle at the surface is more than or equal to 135°.

43. The nanostructure or the nanostructured membrane separator according to any one of claims 1-39, wherein the ion separation or preconcentration is achieved by inducing high contact angle mismatch between aqueous media relative to the top surface and the porous nanoshells inside the pores; and wherein the contact angle inside the pores is between 20-80°.

44. The nanostructure or the nanostructured membrane separator according to any one of claims 1-39, wherein the ion separation or preconcentration is achieved by inducing high contact angle mismatch between aqueous media relative to the top surface and the porous nanoshells inside the pores; and wherein the contact angle inside the pores is between 22.5-79°.

45. The nanostructure or the nanostructured membrane separator according to any one of claims 1-39, wherein the ion separation or preconcentration occurs inside the pores of the metal nanoshells.

46. The nanostructure or the nanostructured membrane separator according to any one of claims 1-39, wherein the nanostructure is prepared by growing hexagonally ordered metal nanoparticles and simultaneously forming porous film of metal nanoshell on the surface of the nanoporous anodic alumina membrane.

47. The nanostructure or the nanostructured membrane separator according to any one of claims 1-39, wherein the hexagonally ordered metal nanoparticles are grown on top and the porous film of metal nanoshell is formed on the interior wall of the pores.

48. The nanostructure according to claim 46, wherein the hexagonally ordered metal nanoparticles are of about 40 nm in diameter and about 50 nm in height.

49. The nanostructure according to claim 46, wherein the metal is Au, Pt or a highly doped semiconductor such as SiGe or Ge.

50. A process for separation, preconcentration, or detection of heavy metal ions in aqueous media using the nanostructure or the nanostructured membrane separator according to any one of claims 1-49.

51. The nanostructure, the nanostructured membrane separator, or the process according to any one of claims 1-50, wherein the detection of heavy metal ions is electrochemical detection.
